(19) United States
(12) Patent Application Publication
(10) Pub. No.: US 2007/0292020 A1
(43) Pub. Date: Dec. 20, 2007

(54) METHOD OF SELECTING THE HARMONIOUS HAIR COLORATION SUITED TO A PERSON

(75) Inventor: Carlo Guidi, St. Gallen (CH)

Correspondence Address: SUGHRUE MION, PLLC, 2100 PENNSYLVANIA AVENUE, N.W., SUITE 800, WASHINGTON, DC, 20037, US

(73) Assignee: CARLO GUIDI, St. Gallen (CH)

(21) Appl. No.: 11/755,974

(22) Filed: May 31, 2007

(30) Foreign Application Priority Data
Jun. 1, 2006 (EP) 06405244.2

(51) Int. Cl. G06K 9/00

(52) U.S. Cl. 382/165

(57) ABSTRACT

A method is given with which it is possible to assign to a person, according to their skin color, eye color and hair color, a hair coloration which supports the overall impression of the person in a harmonious way. For this, a color matrix (M) is used which comprises in total eight color fields (M11, . . . ,M42), which are arranged in two columns (S1, S2) and four rows (Z1, . . . ,Z4). The columns (S1, S2) here are warm and cold colors, the rows (Z1, . . . ,Z4) are the color depth or lightness.

### TECHNICAL FIELD

The present invention is in the field of personal color coordination. It relates to a method for selecting the harmonious hair coloration suited to a person for changing the color of the hair.

### PRIOR ART

For a long time a color and style consultation has been known which was founded and propagated in the 1970s under the name “Color Me Beautiful”. The basic idea is the principle of seasonal typology as a basis for color consultations and color selection and its application to fashion areas. Such a color determination and selection also includes the hair color, through a change in which a person can alter their overall impression.

Countless color nuances in the form of hair colorations are nowadays available on the market. The hair cosmetics companies continually offer new products for new fashion trends, as well as their chemical-technical directions for the hairdresser. However, they make no clearly defined connection between the color and the typology of the person. The color is nowadays chosen on the one hand according to the sensitivity and the desire of the customer, on the other hand according to the experience of the hairdresser and the fashion of the time. Ultimately, however, there in most cases remains uncertainty about the choice of color, the color nuance and the depth of color or color depth (how light, how dark).

On the other hand, the correct choice of color would bring about a clear radiance of the eyes and a fresh overall impression; the facial features would be more defined. The correct choice of color would emphasize the character, the style and the shape.

In the past, various methods have been proposed for selecting or determining the colors suited to a type of person within the framework of optimizing personal radiance.

U.S. Pat. No. 4,561,850 discloses a color coordinator device in the form of an adjustable disk with which it is possible to assign certain cosmetic colors to the skin color and eye color of a person.

U.S. Pat. No. 5,967,562 discloses a method of coordinating colors and styles in which the colors of objects are divided into various color families, which are subdivided into warm, cold and neutral.

EP-B1-0 446 512 discloses a method for selecting colors compatible with a person in which, in a first step, a number of, essentially four, categories of skin color are established. Furthermore, it is possible to establish four sets of color ranges for fabric material which are most compatible with the four skin color categories. It is then possible to match the skin of the person with the corresponding fabric material in order to determine the colors which can best be worn by this person.

However, the known solutions are not suitable for selecting hair colorations which best suit a particular person in terms of color.

### SUMMARY OF THE INVENTION

It is therefore an object of the invention to provide a method which enables an optimum color choice for the hair coloration of a person by dividing people typologies according to the overall impression of skin, hair and eye color.

The object is achieved through the totality of the features of the independent claim. The core of the invention consists firstly in determining the natural hair coloration, skin color and eye color of the person, then classifying the person according to the determined natural hair coloration, skin color and eye color into a matrix field of a color matrix, where the color matrix comprises a plurality of matrix fields which are arranged in two columns, which represent the qualities “warm” and “cold”, and several rows, which represent a graded color depth, and finally selecting a hair coloration lying in the same column of the color matrix for changing the color of the hair. The matrix arrangement of the color fields enables an assignment of hair colorations to a person which avoids an incorrect color choice with certainty.

According to one embodiment of the invention, the color matrix comprises three rows which correspond to the naturally occurring color depths “light”, “medium” and “dark” in people, and a fourth row which corresponds to the artificially produced color depth “extra light”.

In particular, within the color matrix, the color depth is subdivided via the rows into finer stages, where preferably the fine subdivision of the color depth comprises twelve stages.

It goes without saying that, within the invention, the rows and columns of the color matrix can also be swapped.

### BRIEF DESCRIPTION OF THE DRAWINGS

The invention will be explained in more detail below by reference to embodiments in connection with the drawing.

FIG. 1 shows a color matrix with the fine subdivision of the color stages according to a preferred embodiment of the invention;

FIG. 2 shows a highly simplified flow diagram for a method according to a preferred embodiment of the invention;

FIG. 3 shows the color matrix from FIG. 1 with two example classifications of a person and possible hair colorations suited to these classifications.

### EMBODIMENTS OF THE INVENTION

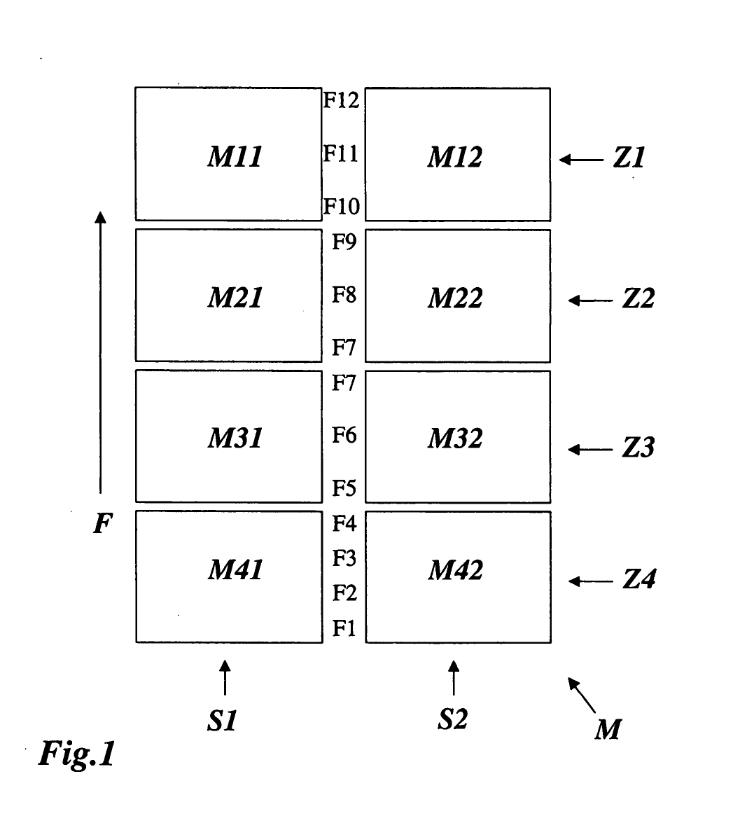

FIG. 1 shows a color matrix with a fine subdivision of the color stages according to a preferred embodiment of the invention. The color matrix M represents a color scale whose color depth F can be divided into a number of stages F1-F12. The color stages from F1 to F9 are the hairdresser's colors and stand for the pigments of the genetic human colors from F1 (=dark) to F9 (=light). Above color depth F10, chemical, artificial and “artistic” colors are classified. The eight matrix fields M11, . . . ,M42 of the color matrix M can furthermore be divided by the hair color depth in conjunction with the eye color and the undertone of the skin into warm or cold (color depth of F1 to F9). The three matrix fields M41, M31 and M21 in the left-hand column S1 of the color matrix M (row Z4=dark, row Z3=medium and row Z2=light) stand for warm colors, the three matrix fields M42, M32 and M22 of the right-hand column S2 (corresponding to dark, medium and light) stand for cold colors.

The two matrix fields M11 and M12 (row Z1), which correspond to a color depth of F10 to F12, likewise stand for warm colors (column S1) and cold colors (column S2); however, they do not correspond to the genetic nature of the person, but are artificial colors (extra light).

Each of the eight matrix fields M11, . . . ,M42 comprises a certain color spectrum from nature which corresponds to an infinite number of different tone shades.

When using the matrix scheme shown in FIG. 1, the overall impression of a person is firstly analyzed, which can be defined as light, medium or dark. The natural hair color is then established as golden (warm) or ashy (cold). In addition, the skin types are checked by establishing the undertone of the skin, which may be golden or blue. In the case of the eye color, it is established how clear or cloudy, how light or dark this is marked. Furthermore, the shade of the eye white is analyzed as clear white or a rather milky color.

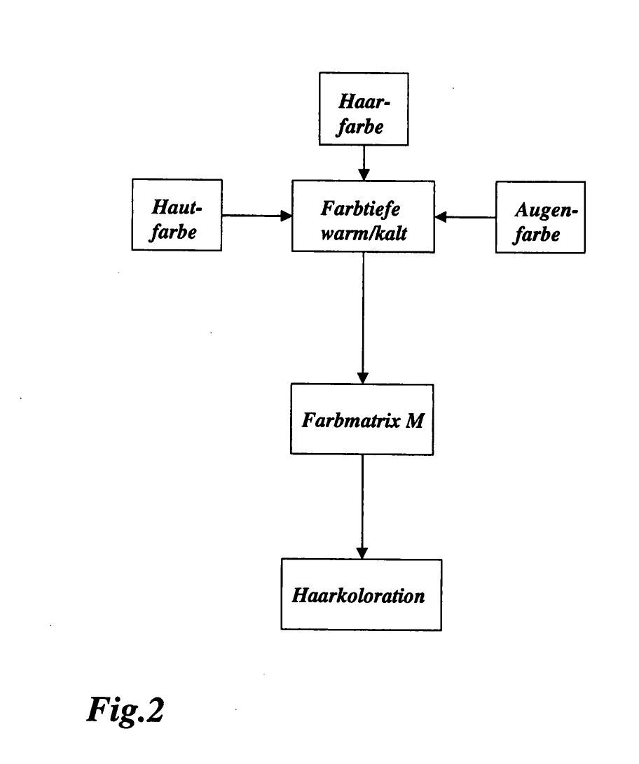

By analyzing the hair, skin and eye color, the genetic pigmentation of the person can be defined as warm of cold and be assigned, according to its lightness (color depth), to a matrix field in the color matrix M in order to carry out the chemical color choice for the hair coloration (FIG. 2).

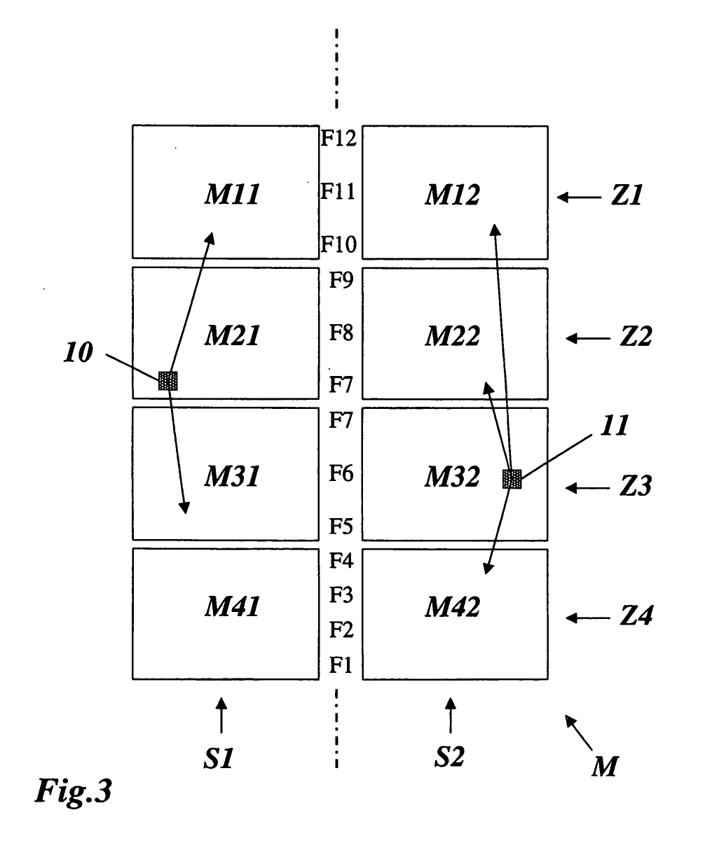

Two examples of a classification are shown in FIG. 3: if a person receives a classification 10 in the matrix field M21 (warm-light), according to the arrows shown, hair colorations from the matrix field M11 (warm-extra light, color depths F10-F12) or from the matrix field M31 (warm-medium, color depths F5-F7), for example, can be selected as suitable. If a person receives a classification 11 in the matrix field M32 (cold-medium), according to the arrows shown, hair colorations from the matrix field M12 (cold-extra light, color depths F10-F12) or from the matrix field M22 (cold-light, color depths F7-F9) or from the matrix field M42 (cold-dark, color depths F1-F4), for example, can be selected as suitable.

When imparting color, moreover, the morphology of the person, the shape of the face, the inner life of the face, but also the physique can be taken into consideration.

For the hairdresser, all of this information results in a clear color aim for an optimal, professional consultation regarding color, shape and style.

The eight matrix fields M11, . . . ,M42 of the scheme can be described as follows, recourse being made to pictorial elements for the characterization:

Matrix Field M41 (Warm-Dark):

The dark type with undertone of the skin warm is lively and warm. The hair is dark brown/chestnut brown, the skin is gold-olive, warm beige or ivory. The eye color is a rich olive green, a hazelnut brown or a black-brown.

The temperament of the person is highly instinctive with strong facial features. The eyes stand under arches, the body shapes and movements are blocky. The nature of the person is the earth and natural type who is distinguished by elemental force, instinct, indestructibility, authenticity, resistance.

The rich, earthy, full, medium to dark tones best suit the typology, the colors have a warm undertone. These dark, warm, rich and lively colors are most likely to be found on a walk in a chestnut wood.

Matrix Field M42 (Cold-Dark):

The dark type with undertone of the skin cold is lively, cool, clear and full of contrast. The hair is dark brown, black, dark chestnut brown. The skin is black, a cool brown, olive or a cool beige. The eyes are dark brown, hazelnut brown and olive green.

The temperament of the person is distinguished by sharp facial features and delicate bone structure. The nature corresponds to the power type with vision, authority, endurance and curiosity. The undertone of the skin color is blue with clear, luminous base colors.

These dark, cold and clear colors can be found in the snowy landscapes of winter when the sun reflects from a bright sky into the ice crystals.

Matrix Field M31 (Warm-Medium):

The warm medium type with undertone of the skin warm is golden and clear. The hair is golden, strawberry blond and red. The skin is ivory or porcelain in color and often has freckles. The eye color is petrol blue, a warm green shade or a clear, light hazelnut brown.

The temperament of the person is distinguished by large bright eyes, high cheekbones, a curve-, wasp-waist and shining teeth. The nature is the atmospheric type. This is communicative, active, dynamic, mobile and quick.

The colors are gold, orange, red, Venetian red, clear, warm colors with a golden undertone of the skin. These colors can be found in an apple tree and are between the dark deep shades of the trunk and the shimmering green of the leaves. The fruits predominate in red-yellow shades between the green-golden leaves. The warm colors dominate.

Matrix Field M32 (Cold-Medium):

The medium type with undertone of the skin cold is muted and pale. The hair is mid-brown, ash blond and ash brown. The skin color is beige, muted ivory or pink-beige. The eye color is gray-green, muted hazelnut brown and gray-blue.

The temperament of the person is distinguished by a high upper head section, a swan neck and by a delicate bone structure. The nature is the intellectual type. Knowledge, perfection, precision, technology and current affairs are arguments which characterize this typology.

The colors are cool colors such as mahogany red, red-violet, mahogany brown and ash tones. The undertone of the skin is bluish. These colors can be found in a cocktail of strawberries, raspberries and cherries. By mixing the cherry-red color with the strawberry, raspberry shades, the cocktail shimmers in various light red shades which radiate a washed-out, powdery red.

Matrix Field M21 (Warm-Light):

The light type with undertone of the skin warm is soft and delicate. The hair is blond or gold-gray. The skin tones are peach tones, ivory or warm beige. The eyes are blue, aquamarine, blue-green.

The temperament of the person is distinguished by a dilated skin in light, pale tones. The hair has natural blond strands. The nature is communicative, intellectual and dynamic.

The colors are warm colors such as natural gold, gold, brown and ash gold. The undertone of the skin is golden. These clear colors are to be found in nature which is awakened by the warmth of the sun's rays. The growth of plants produces shades from yellow, green to gold.

Matrix Field M22 (Cold-Light):

The light type with undertone of the skin cold is soft, delicate, feminine. The hair is ash blond, pale blond, light blond. The skin tones are ivory and cool beige. The eyes are gray, gray-blue and muted blue.

The temperament of the person is rosy-gray, light and pale, embodied by a delicate bone structure and a long neck. The nature is characterized by precision and knowledge.

The colors are cool colors such as ash, ash intense, ash violet and violet. The undertone of the skin is bluish. These colors can be found on a hot summer's day when the atmosphere shimmers against the heat. The colors lose their intensity as a result of the thermal irradiation from the sun and look powdery. Alongside a river, blue colors are seen in conjunction with gray elements of stones, where, as a result of various water depths, color shadings from gray, white and blue are to be found. Light colors dominate as a result of the shimmering of water play.

Matrix Field M11 (Warm-Extra Light)/M12 (Cold-Extra Light):

Avantgarde/trend fashion, the sense of using an extreme color. Here, the style personality of the person counts much more in order to be able to embody with these extreme, dramatic, funny, eccentric colorations. If the genetics of warm or cold are respected, then these colorations give a bright expression. These hair colorations brighten up the eye color and ensure a fresh, radiant expression (including reviving, freshening up the appearance). This type of hair coloration is only appropriate with a light skin color, not with a dark skin color.

The extra light warm colors can be found in a cocktail of champagne and pineapple. By contrast, the extra light cold colors can be found in an oriental cocktail of champagne and rambutan fruits with crystalline ice cubes. The light effects of this mixture are a color play from extra light to violet shades.

### EXAMPLES

The aim is a color change using a chemical hair dye. When changing the color, the seven contrast colors always play a role; the shade contrast color type, the light-dark contrast, the cold-warm contrast, the complementary contrast, the simultaneous contrast, the saturation contrast and the quality contrast. It must be observed that an unlimited number of examples are possible per matrix field.

### 1. Example Matrix Field M41 (Warm-Dark)

A person with skin color beige gold, hair color chestnut brown and eye color hazelnut brown. Color depth of the natural hair color F2 to F4.
Color change with color aim direction light (color depths from F6 to F10), i.e. direction natural gold, gold, gold-red and red-gold/red-brown.
Color change with color aim direction dark (color depths from F2 to F4), i.e. direction brown intense, dark golden brown.
Cold colors such as mahogany, ash, violet are to be avoided.

### 2. Example Matrix Field M42 (Cold-Dark)

A person with skin color cool beige, hair color dark chestnut brown, eye color olive green. Color depth of the natural hair color F1 to F4.
Color change with color aim direction light (color depths from F6 to F12), i.e. direction red mahogany, violet, cool brown.
Color change with color aim direction dark (color depths from F1 to F3), i.e. direction blue-black and mahogany intense, red intense.
Warm colors such as golden red, gold, natural gold are to be avoided.

### 3. Example Matrix Field M31 (Warm-Average)

A person with skin color ivory, hair color golden, eyes light hazelnut brown. Color depth of the natural hair color F5 to F7.
Color aim direction light (color depths from F8 to F12), i.e. golden red, natural gold, Venetian red.
Color aim direction dark (color depths from F7 to F4), i.e. golden red, dark blond golden red, gold and brown-red.
Cold colors in violet shades are to be avoided since the lightness of the skin is thereby muted.

### 4. Example Matrix Field M32 (Cold-Medium)

A person with skin color beige, hair color dark ash blond, the eyes are a hazelnut brown. Color depth of the natural hair color F5 to F7.
Color aim direction light (color depths from F7 to F12), i.e. violet-ash, Beaujolais red.
Color aim direction dark (color depths from F7 to F3), i.e. brown, mid-brown, brown mahogany, mid-brown-violet, ash tones, clear color.
Warm colors such as red gold are to be avoided.

### 5. Example Matrix Field M21 (Warm-Light)

A person with skin color warm beige, hair color golden blond, the eyes are blue-green. Color depth of the natural hair color F7 to F9.
Color aim direction light (color depths from F9 to F12), i.e. natural gold, gold, special blond-brown.
Color aim direction dark (color depths from F7 to F5), i.e. dark clear colors such as light brown-gold and dark blond-brown intense.
Cold dark colors above F5 and matt intense blue tones are to be avoided.

### 6. Example Matrix Field M22 (Cool-Light)

A person with skin color cool beige, hair color ash blond, the eye color gray-blue. Color depth of the natural hair color from F7 to F9.
Color aim direction light (color depths from F8 to F12), i.e. special blond, ash violet, pearl, special ash intense.
Color aim direction dark (color depths from F9 to F6), i.e. ash, blue, violet, cold tones.
Golden red tones are to be avoided.

### 7. Example Matrix Field M12 (Cool-Extra Light)

A person with skin color muted pink, hair color ash blond, eye color gray. Color depth of the natural hair color from F7 to F9.
Color aim is an eccentric lightness value in pastel, platinum, ash violet.
Golden tones are to be avoided.

### 8. Example Matrix Field M11 (Warm-Extra Light)

A person with skin color ivory, hair color blond, eye color blue-green. Color depth of the natural hair color from F7 to F9.
Color aim is an eccentric lightness value direction natural gold.
Color tones in ash intense are to be avoided.

### LIST OF REFERENCE NUMERALS

10, 11 Classification
F Color depth
F1, . . . ,F12 Stage (color depth)
M Color matrix
M11, . . . ,M42 Matrix field
S1, S2 Column (matrix M)
Z1, . . . ,Z4 Row (matrix M)

1. A method for selecting the harmonious hair coloration suited to a person for changing the color of the hair, comprising the following steps:
determination of the natural hair coloration, skin color and eye color of the person;
classification of the person according to the determined natural hair coloration, skin color and eye color into a matrix field of a color matrix, where the color matrix comprises a plurality of matrix fields which are arranged in two columns, which represent the qualities “warm” and “cold”, and several rows, which represent a graded color depth,
assignment of a hair coloration lying in the same column of the color matrix for changing the color of the hair.

2. The method as claimed in claim 1, wherein the color matrix comprises three rows which correspond to the naturally occurring color depths “light”, “medium” and “dark” in people.

3. The method as claimed in claim 2, wherein the color matrix comprises a fourth row which corresponds to the artificially produced color depth “extra light”.

4. The method as claimed in claim 3, wherein, within the color matrix, the color depth is subdivided via the rows into finer stages.

5. The method as claimed in claim 4, wherein the fine subdivision of the color depth comprises twelve stages.
